(19) United States
(12) Patent Application Publication
(10) Pub. No.: US 2012/0330789 A1
(43) Pub. Date: Dec. 27, 2012

(54) LIMITATION PROTOCOL

(76) Inventor: Ryan A. Heck, Reno, NV (US)

(21) Appl. No.: 13/492,876

(22) Filed: Jun. 10, 2012

Related U.S. Application Data
(60) Provisional application No. 61/501,668, filed on Jun. 27, 2011.
(60) Provisional application No. 61/584,285, filed on Jan. 8, 2012.
(60) Provisional application No. 61/657,798, filed on Jun. 10, 2012.

(51) Int. Cl. G06F 21/24; G06Q 30/06; G06F 15/16

(52) U.S. Cl. 705/26.41; 726/27

(57) ABSTRACT

The present disclosure provides a computer implemented method of limiting access to an electronic information source. A limitation protocol is defined that provides for one or more access events. A user may access the electronic information source if an access event is available. If an access event is not available, the user is not allowed to access the electronic information source.

### CROSS REFERENCE TO RELATED APPLICATIONS

The present application claims the benefit of, and incorporates by reference, U.S. Provisional Patent Applications Ser. Nos. 61/501,668, filed Jun. 27, 2011, 61/584,285, filed Jan. 8, 2012, and 61/657,798, filed Jun. 10, 2012.

### FIELD

The present disclosure generally relates to a method, system, computer program product, and computer implementation for limiting access to one or more aspects of an electronic device, such as programs, including those that provide access to electronic information sources.

### SUMMARY

The present disclosure provides a method of limiting access to one or more aspects of an electronic device. For example, the method may limit access to one or more programs, such as those that provide access to an electronic information source. In a particular implementation, the method limits access to an electronic information source, such as text messages, email messages, voice mail messages, and social media, for example, FACEBOOK and TWITTER. In another implementation, the method limits access to programs that provide access to internet resources, such as the World Wide Web. In yet another implementation, the method limits access to programs, including apps, for example, those that provide games or productivity applications (such as word processing and presentation development functions).

In one embodiment, the method includes defining a limitation protocol. In another embodiment, the limitation protocol is predefined, such as a default protocol in a computer program implementing the method. The limitation protocol defines a schedule of access events. Each access event allows access to at least one aspect of an electronic device, such as program, for example a program providing access to an electronic information source. In a particular implementation, access is allowed to an electronic information source.

In particular embodiments, the method includes determining whether a user's request to access an aspect of the electronic device, such as a program, for example a program providing access to an electronic information source, complies with the limitation protocol. The method determines whether there is an authorized access event. In one example, if no access event is authorized, the user is not allowed to access the electronic information source or program.

In one implementation of a user-defined limitation protocol, defining a limitation protocol includes defining a notification filter. During execution of the limitation protocol, information from the electronic information source, or program, is evaluated to determine whether it meets the criteria of the notification filter. If the criteria is met, when an access event is authorized, the user is notified that information meeting the notification criteria has been identified. Information to be evaluated may be pulled from the program or electronic information source or evaluated in response to an information push from the program or electronic information source.

In another implementation of a user-defined limitation protocol, defining a limitation protocol includes defining an exception filter. During execution of the limitation protocol, information from the electronic information source or program is evaluated to determine whether it meets the criteria of the exception filter. If the criteria is met, the user is notified that information meeting the exception filter criteria has been identified. Information to be evaluated may be pulled from the program electronic information source or evaluated in response to an information push from the program or electronic information source. In one implementation, the user is allowed to access information meeting exception filter criteria even if no access event is otherwise authorized. In a specific implementation, when exception filter criteria event is met, an access event is authorized by the method. In another specific implementation, the user is allowed to access only information meeting the exception filter criteria and a general access event is not authorized.

In another implementation, a user may be given the option to access a program or electronic information source even if no access event is authorized. Such options could fulfill a user's desire to “cheat” on the protocol or to obtain access in case of particular need or compulsion. In one example, the user may obtain approval for such access through a third party. In another example, the user may pay a fee (or other penalty) to obtain access. The fee, in a particular example of the present disclosure, serves as revenue for a provider, such as a company, making the method of the present disclosure available to the user. In another particular example, the user can select that the fee is paid to a third party, such as an individual, or a charity. In yet another example, the user may be given a limited number of opportunities to access the program or electronic information source without an otherwise approved access event from the limitation protocol. In a specific example, the method provides for both third-party authorization and pay (penalty) access.

There are additional features and advantages of the various embodiments of the present disclosure. They will become evident from the following disclosure.

In this regard, it is to be understood that this is a summary of the various embodiments described herein. Any given embodiment of the present disclosure need not provide all features noted above, nor must it solve all problems or address all issues in the prior art noted above.

### BRIEF DESCRIPTION OF THE DRAWINGS

FIG. 1 is a flowchart illustrating a process for creating a limitation protocol.

FIG. 2 is a flowchart illustrating a process for applying notification and exception filters for a limitation protocol.

FIG. 3 is a flowchart illustrating a process for evaluating a user request to access an electronic information source.

FIG. 4 is schematic diagram of an operating environment useable with the method of the present disclosure.

FIG. 5 is a block diagram illustrating an example system architecture for a limitation protocol tool.

FIG. 6 is a block diagram illustrating an example system architecture for a configuration module of limitation protocol tool.

FIG. 7 is a block diagram illustrating an example system architecture for a protocol management module of limitation protocol tool.

FIG. 8 is a block diagram illustrating an example system architecture for an exception handling module of limitation protocol tool.

FIGS. 9a-9c are flowcharts illustrating generalized techniques for requesting, intermediating, and processing cheat requests.

FIGS. 10a-10d are flowcharts illustrating generalized techniques for requesting, approving/disapproving, intermediating, and processing lifeline requests.

FIGS. 11a-11c are flowcharts illustrating generalized techniques for electronic information source processing, device operating system intermediating, and software processing of notification filters.

FIGS. 12a-12c are flowcharts illustrating generalized techniques for electronic information source processing, device operating system intermediating, and software processing of exception filters.

FIG. 13 illustrates a home screen of a program according to an embodiment of the present disclosure running on a mobile device.

FIG. 14 illustrates a limitation protocol start/end screen of a program according to an embodiment of the present disclosure running on a mobile device.

FIG. 15 illustrates a select access frequency screen of a program according to an embodiment of the present disclosure running on a mobile device.

FIG. 16 illustrates a select electronic information source screen of a program according to an embodiment of the present disclosure running on a mobile device.

FIG. 17 illustrates a filter selection screen of a program according to an embodiment of the present disclosure running on a mobile device.

FIG. 18 illustrates a cheat configuration screen of a program according to an embodiment of the present disclosure running on a mobile device.

FIG. 19 illustrates a lifeline selection screen of a program according to an embodiment of the present disclosure running on a mobile device.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together.

The present disclosure provides a method of restricting a user's access to aspects of an electronic device. For example, the method restricts access to electronic information sources or programs or apps, including those providing access to electronic information sources. If a program provides access to more than one electronic information source, or otherwise constitutes multiple aspects of the electronic device, the method may selectively restrict access to the electronic information sources/aspects, while providing access to the program.

Particularly with the increased use of smart phones, feature phones, personal digital assistants, tablet computing devices, netbooks, laptops, and other mobile electronic devices, information and other resources are readily available for user consumption. However, the ubiquity and ease of information and resource access can lead users to compulsive or neurotic behavior. For example, users may excessively access email, social media, text messaging, the World Wide Web, etc. Particularly when information access is part of a user's work, such as jobs that involve regular use of email, it can be difficult for users to resist the urge to access information. For example, if a user whose job requires heavy email use goes on vacation, or even goes home, the user may be tempted to frequently check their email even though they are not at work. Such behavior can lead to stress and can negatively impact the user's relationships with their family and friends.

In theory, the user could always simply resist their urge to access information or programs. This can be much more difficult in practice, as with many addictive or compulsive behaviors. An insight of the present disclosure is that users may need electronic interventions in order to curb undesired behavior with respect to the use of electronic devices. A further insight is that users would voluntarily choose to enable such interventions. Yet another insight is that those associated with the user would limit the user's impact, for their own benefit or for the user's benefit.

The present disclosure provides a method, system, computer product, etc., implemented in various ways, to discourage or prevent users from excessively accessing programs/applications or electronic information sources in an electronic device, such as phones, smartphones, feature phones, personal digital assistants, media devices (such as the iPod and iPod Touch), tablet computers, netbooks, laptops, personal computers, or other electronic devices, including mobile electronic devices. In some implementations, the electronic device is a mobile electronic device. In a specific example, the mobile electronic device is a smartphone. In another specific example, the mobile electronic device is a tablet computer.

In specific examples, the method is used to discourage/limit access to electronic information sources. As used herein, electronic information source refers to information sources such as a communication program, for example, an email program or a text messaging program; a social media program, such those allowing access to services such as FACEBOOK, GOOGLE+, or TWITTER; or programs that allow access to the World Wide Web. In a specific example, the electronic information source is a communication program. In another specific example, the electronic information source is a social media program. In yet another specific example, the electronic information source is the World Wide Web. In a more specific example, the electronic information source is one or more specific web pages accessible via the World Wide Web, such as those that provide access to electronic information sources, such as email, social media, etc.

In some implementations, access to the electronic information source is completely blocked, such that information already received from the source is blocked along with information not yet presented to the user. In other embodiments, the user is allowed to access old information, but is not allowed to access new information, except as provided by a limitation protocol that may be defined by the user, for the user, or predefined in hardware or software. For example, data push or pull features may be disabled. In some embodiments, the user is allowed to send, but not receive, new communications.

Although the following disclosure is generally described with respect to electronic information sources, the method may be applied to other aspects of the electronic device, such as programs. The method, for example, may be used to limit access to games, media content, work or productivity (word processing, financial/spreadsheet or presentation development applications, for example) programs or applications (“apps”), etc.

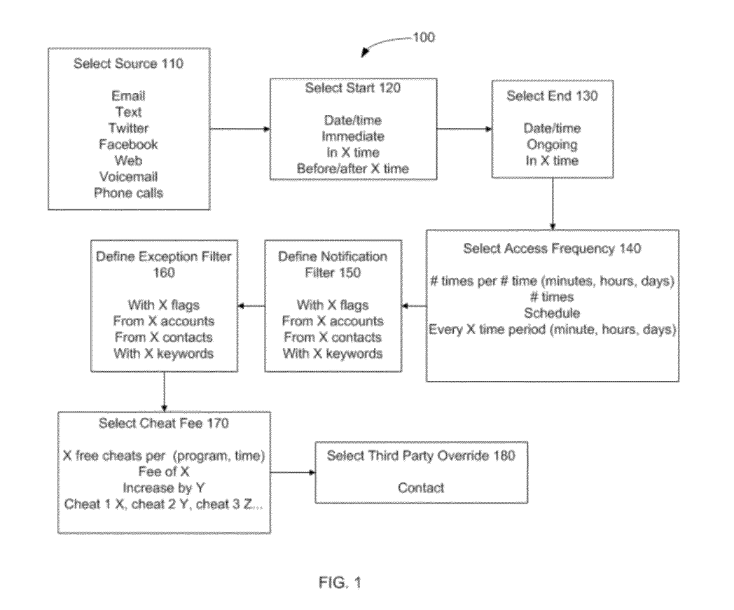

In one implementation, shown in flowchart form in FIG. 1, a method 100 is provided for defining a limitation protocol that will control access to an electronic information source. In one example, the method 100 is carried out by a user, who may be the same or different than the user whose access is to be limited. For example, the user who carries out method 100 may be a person of authority or influence over the user of the electronic device, such as a spouse, significant other, friend, parent, supervisor, social worker, or legal representative (such as law enforcement personnel). A parent may wish to limit a child's access to certain aspects of an electronic device, such as phone features, after a certain time of night, for example. A spouse or significant other may wish to limit their spouse or significant other's access in the evenings. A supervisor may wish to limit employees' access to non-work related activities during working hours. A social worker/law enforcement officer may wish to limit a user's access to certain types of information sources.

In a specific embodiment of the present disclosure, the method is used to limit a user's access to aspects of an electronic device while the user is driving. Drivers distracted by phone calls or text messages, for example, are much more likely to cause accidents. However, it can be difficult for the drivers, even if they wish to, to disengage from their electronic devices. The presently disclosed method can assist such drivers by removing the temptation to use their devices while driving, as access to the device is prevented or discouraged by the limitation protocol.

The user may be presented with a graphical user interface displaying various options and provided with means to select the desired option. The GUI may present the user with, for example, selectable radio buttons, drop down menus, numeric steppers, or dials to define the parameters of the limitation protocol. The steps of method 100 need not be carried out in the order shown. In addition, every step of method 100 need not be performed. In some examples, certain parameters are not used or are predefined by the hardware or software, rather than being left to user selection. In addition, the user may be presented with default values, which the user can opt to change or leave as is. In particular implementations of the method of the present disclosure, method 100 is omitted. For example, one or more limitation protocols may be predefined in the hardware or software (including firmware) of the electronic device.

According to the method 100, electronic information sources subject to the particular limitation protocol are selected in step 110. In step 120, a start time is selected for the limitation protocol. The start time may be, for example, immediate, at a specified date/time, or when a specified number of time units have passed (for example, the user may select “start in 2 hours”). In step 130, an end date is selected for the limitation protocol. The end date may be, for example, a specified date/time or a specified number of time units from the start time (for example, “run the protocol for the next 2 weeks”). Steps 120 and 130 need not be explicitly carried out. For example, a user may be presented with the option for choosing a protocol duration, with the assumption that the protocol will begin once an execution command is received. In further implementations, the end time is omitted, so that the limitation protocol is ongoing.

The method 100 can allow more complex schedules to be set. For example, the limitation protocol may be set to operate only on the weekends or during non-work hours. In such cases, steps 120 and 130 may be repeated or otherwise used to set multiple start and end times. In another configuration, the method 100 may include a calendar feature for setting a schedule or sync with an external calendar feature (such as Microsoft Outlook or Apple iCal).

In step 140, the frequency electronic information sources may be accessed is specified. In one example, an access event refers to a single query of the electronic information source, such as a data pull (or allowed data push) from the electronic information source. In another example, access frequency refers to a single access of a program, including a program providing access to an electronic information source. A duration for an access event may be selected, including predetermined, in some configurations. For example the access event may be defined as active for a particular time period, such as a certain number of minutes, or until an application is terminated or suspended. After the access event duration expires, the user may be prevented from further accessing information in the electronic information source or denied access to a program (for example, the subject program may be terminated).

In one configuration, the access frequency is defined as how many times the electronic information source can be accessed over a particular time period, such as an hour, day, or week. For example, while on vacation, a user may wish to limit email access to two times per day. In such cases, the user may choose when those two access events are carried out over the course of the day. In another example, the user can use access events at will, but no more access events will be allowed until the limitation protocol ends or more access events are authorized by the terms of the limitation protocol. The user can select zero access events for the limitation protocol.

In a further configuration, a minimum time period is set between access events. For example, the user may select that once the electronic information source has been accessed, another access event may not be carried out until a period of time has passed. Restrictions can be combined. In a particular implementation, access events are subject to a total per time period and a minimum time between events. A user could, for example, specify a maximum of three access events per day, with at least four hours between each access event.

In some cases, the user chooses to access the electronic information source once a new access event is available. In other cases, the method of the present disclosure alerts the user regarding new information received by the electronic information source since the last access event. In specific examples, the user may specify certain types of information of which they wish to be altered. For example, in step 150 of the method 100, specific notification filters are established that define what information should be “pushed” to the user. The filters may include, for example, specific key words, contacts, email accounts, phone numbers, or status indicators (such as priority flags) of which they wish to be notified once an access event is authorized.

In some cases, the user is presented with the full details of the information-such as being presented with an entire email, text message, post, etc. In other cases, the user is presented with a summary of the information. The user can then choose whether or not to access the electronic information source. For example, the user may be notified of the account from where the information originated (such as an email account or text number) or an excerpt of the information (such as the “re” line of an email or a selected number of characters of the information).

The user may wish to receive some information regardless of whether an access event is available, particularly when the electronic device is used in whole or part for work related activities. Some implementations of the method 100 allow the user to set up exception filters that notify a user of information containing specific key words or status indicators (such as priority flags), including those from contacts, email accounts, phone numbers, or combinations thereof. For example, a user's assistant or supervisor may be given permission to contact the user if the assistant assigns a priority status indicator to the communication. Some contacts or other criteria can be designated to always be sent to the user. For example, a user's boss, parent, etc. may be designated as having their communications always reach the user. In some cases, these criteria are user defined. In other cases, the criteria are predetermined by a program or a third party, such as a parent, spouse, supervisor, IT department, etc.

In the event a communication or other information from an electronic information source meets a filter condition, the electronic device may proactively alert the user of the communication, either under normal operation of the device (and appropriate operating system or application software) or by a feature implemented as part of application software implementing the method 100. The alert may be audible, tactile (such as vibration), visual, other appropriate means, and combinations thereof.

Accordingly, in step 160, exception filters may be defined that will allow certain communications to be transmitted to the user, even if an access event is not authorized. In a particular embodiment of the present disclosure, an “exception” is anything that creates access events outside of the limitation protocol/normal access event availability. As described further below, exceptions may include, without limitation, cheats, lifelines, and exception filters.

In some cases, when an exemption occurs, the user is merely authorized to access the specific communication or information meeting the filter criteria. In other cases, an access event is authorized by the limitation protocol. In such cases, the user may be allowed to access information that does not meet the filter criteria in addition to information that does meet the filter criteria. The exception filter may be affirmatively notified that the filter criteria have been met, such as being notified of the additional access event or all or part of the information meeting the filter criteria. Notification may be carried out as described above for the notification filters of step 150.

In one example, the user is allowed to access all new information from the electronic information sources subject to the limitation protocol by creating an additional access event. In a more particular example, the new access event is incorporated into the limitation protocol. For example, if the limitation program defined a minimum time between access events, a user might be allowed to violate the protocol in order to receive information meeting the filter criteria defined in step 160. In some cases, this additional access event does not count against the user. In other cases, however, the next access event would not be authorized until the minimum time had passed from the access event generated based on the filter conditions. In another example, the access event triggered by the filters of step 160 counts against an access event limitation per time period. For example, if the user had allowed for two access events per day, and already used one, the access event triggered by the filters of step 160 would count as the final access event for the day. Additional access events could be authorized according to the criteria of the filters specified in step 160 if additional information was identified meeting the filter criteria. For example, even if no access events were available to be authorized, an additional access event, or access to the specific information, is authorized in particular implementations of the present disclosure.

In another embodiment, when information meeting the exception filters is identified, the user is only provided with the information meeting the filter criteria, and is not given access to other information from the electronic information source.

In some implementations, the method 100 gives the user options for cancelling or modifying a limitation protocol or for creating access events outside of the preselected schedule. In one example, the user may choose to freely cancel or modify the limitation protocol. The user may also be given an option to create an additional access event. However, for at least some users, the ability to freely cancel or modify limitation protocols, or to freely create additional access events, may defeat the intent of the present disclosure. For such users, the method 100 provides options for further curtailing the user's ability to access electronic information sources.

Thus, in one implementation, the method 100 does not allow the limitation protocol to be cancelled or modified prior to any termination date set when the limitation protocol was initiated. Additional access events may not be created, or at least not more than a predetermined number. In another implementation, the limitation protocol may be modified or cancelled, or additional access events created, with a penalty to the user, such as payment of a fee, through appeal to a third party, or through a “gambling”/random feature, which may include the payment of a fee.

In step 170, the “cheat” conditions are set for the limitation protocol. For example, a user may select the fee for creating an additional access event. The user may thus choose a fee sufficient to provide a desired deterrent value. In other examples, the fee is preset in the method 100. The fee may be consistent between the creation of access events and termination/modification of a limitation protocol, or the fees may be different. For example, the fee may be higher to terminate a limitation protocol completely than to create a single additional access event. In another example, during the course of a limitation protocol, fees increase (either in a preset manner or as predetermined by a user) for each additional access event created. A limit may be set as to the number of additional access events that can be created, regardless of penalty, during a limitation protocol. The user may be provided with one or more “free passes” to create additional access events during a limitation protocol, including before a fee or third party approval is required.

According to an aspect of the present disclosure, the fee may be used as part of a business model based on the implementation of the method 100. The fee, whether preset or user defined, may be collected by a business as part of the provision of software or hardware carrying out method 100. In some cases, the method 100 may be provided to a user for free or at a reduced cost, as the business generates revenue based on instances of users wishing to violate a limitation protocol.

According to another aspect of the present disclosure, the fee may be paid to another individual or company, which may be predetermined or selected by the user. In a particular embodiment, a charity, such as a user-selected charity, is paid the limitation protocol violation fee.

In some implementations of the method 100, in step 180, the user may delegate authority to one or more individuals to cancel or modify a limitation protocol or to create additional access events. For example, a user may contact a user's work assistant or colleague, supervisor, therapist/counselor, or spouse, who has been delegated such authority and request that they take action as desired by the user. Having to contact another individual may encourage users to honor a limitation protocol, yet gives the user the ability to modify or terminate the limitation protocol, or create additional access events, if the user believes such action is appropriate, and the delegated individual agrees.

In a particular example, the method 100 provides an interface for the user to request the third party to override the limitation protocol. The method may then notify the third party and provide information on how to override the limitation protocol. For example, the third party may be provided with a code that will allow an additional access event or allow modification of the limitation protocol. If the third party deems appropriate, the third party can share the code with the user, who can then enter the code into an interface to the method 100. In another example, the third party can directly access the method 100, such as through a software application, web interface, etc. In which case, the third party can modify the limitation protocol, authorize the user to make changes, or allow data to be pushed to the user from the electronic information source. In yet another example, the method 100 includes the third party override code as an exception filter that is not shared with the user, but with the third party. In some cases, the exception filter/code is not shared with the third party until the user requests that the third party provide access. The request to a third party, in some implementations, must first be obtained by paying a fee, as described above with respect to cheats.

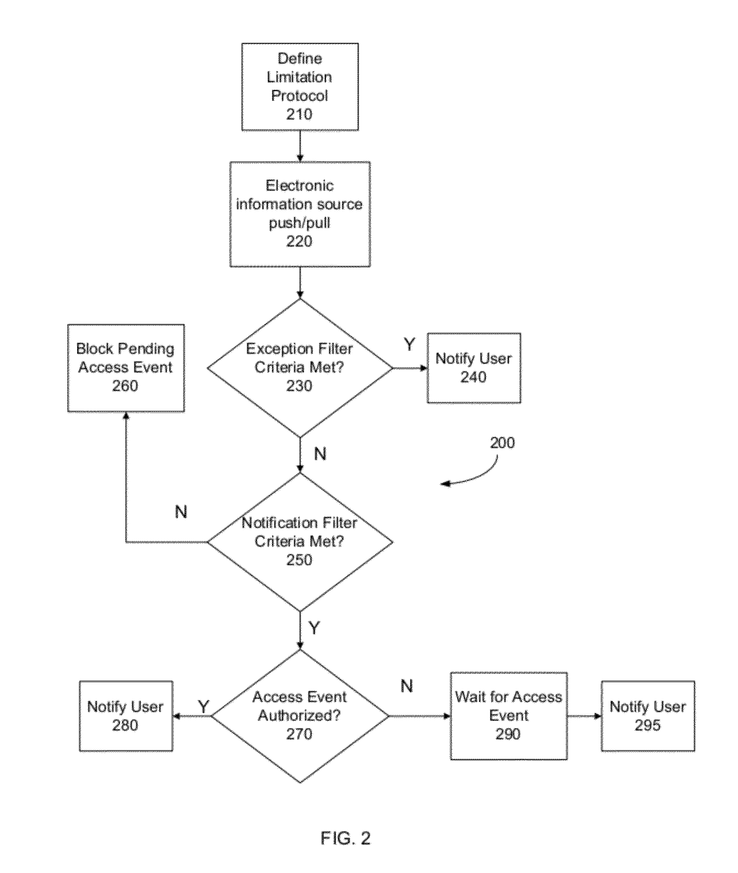

FIG. 2 illustrates a method 200 for using the notification and exception filters set in steps 150 and 160 of method 100 (FIG. 1). Although the method 200 describes both notification and exception filters, the method 200 can be carried out with only one type of filter.

A limitation protocol is defined in step 210, such as using method 100. In step 220, an electronic device pulls information from an electronic information source or receives a push of information from an electronic information source. In the case of an information pull, the limitation protocol may be provided with user configuration data (such as login ID/password) for one or more electronic information sources. In decision 230, information received from the push/pull is compared with the exception filters. If the filter criteria are met, the user is notified in step 240. If the exception filter criteria are not met, the method proceeds to step 250.

In step 250, the method 200 checks to see if information received from step 220 meets the criteria of notification filters. If not, access to the information is blocked, in step 260, until the user accesses the information during an access event. If the information does meet the notification criteria, the method 200 proceeds, in step 270, to see whether an access event is available. If an access event is available, the user is notified of the information in step 280. If an access event is not available, the method waits for an access event to become available, in step 290, and then notifies the user of the information in step 295.

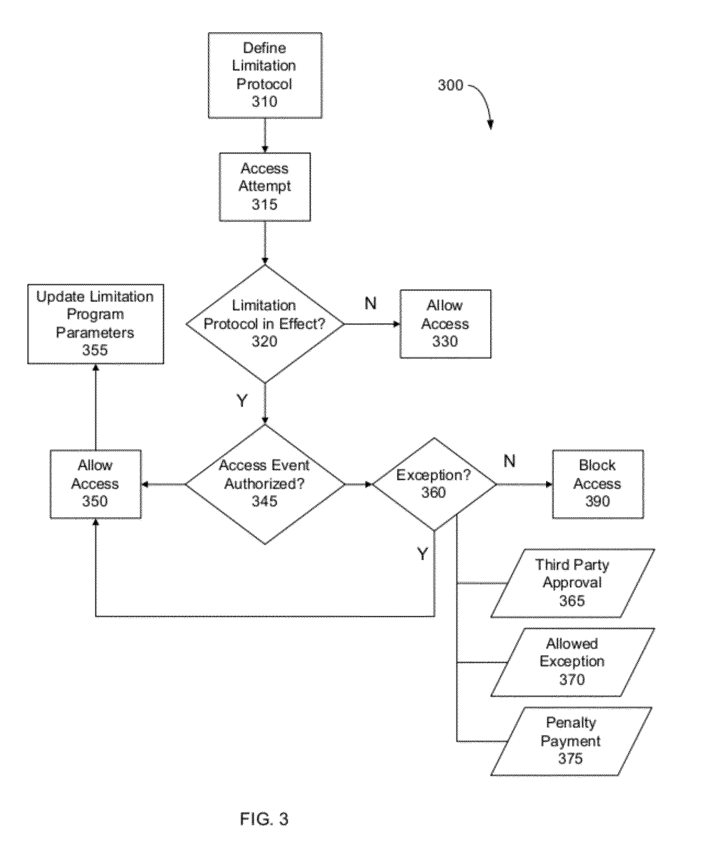

FIG. 3 illustrates a method 300 that may be used when a user attempts to access an electronic information source. A limitation protocol is defined in step 310. In step 315, a user attempts to access an electronic information source. In step 320, the method checks to see whether the limitation protocol is currently in effect. It not, the user, in step 330, is allowed to access the electronic information source.

If, in step 320, it is determined that limitation protocol is in effect, the method checks, in step 345, to see whether an access event is authorized. If an access event is authorized, the user is allowed access to the electronic information source in step 350. In step 355, the limitation protocol is updated, as appropriate, to reflect that the user has used an access event. For example, the access event may be charged against a limited number of access events for a time period.

In decision 360, if an access event was not available in decision 345, the method checks to see whether there is an exception that would allow access to the electronic information source in the absence of an access event. For example, the decision 360 checks to see whether an additional access event may be created because the user received third party approval in process 365, because the user has available exceptions in process 370, or the user has made a penalty payment to obtain additional access events in process 375. If an exception is available from one of processes 365, 370, 375, or other “cheat” conditions are met, the user is allowed access to the electronic information source in step 350 and the limitation protocol parameters are updated in step 355.

If decision 360 finds no exception, step 390 blocks the user's access to the electronic information source.

The method of the present disclosure may be implemented in a number of ways. In one example, the method is made part of the general operating system of a device, such as being implemented as part of Microsoft Windows, Apple iOS, Apple OSX, Google Android, BlackBerry OS, or HP's WebOS. In another example, software programs running on the operating system can implement the features of method 100. For example, the method may be implemented in an application program, such as an “app” for purchase in smart phone application marketplace. In another example, the method is integrated into individual applications, such as programs running on an operating system. For instance, the method may be integrated into a text messaging program, an email program, a web browser, or a social media program.

In examples where the method is implemented in a separate program that interfaces with an underlying operating system or other programs, in one configuration, the program does not allow the user to access one or more programs that access electronic information sources unless there is an available access event. In another configuration, the user may access programs that access electronic information sources, but the program implementing the method may, for example, block communication requests (such as smtp, sms, http, or TCP/IP communications) from such programs, or otherwise disable access to new information. Under such an implementation, a user may be able to access old information, but is prevented from accessing new information unless there is an approved access event available.

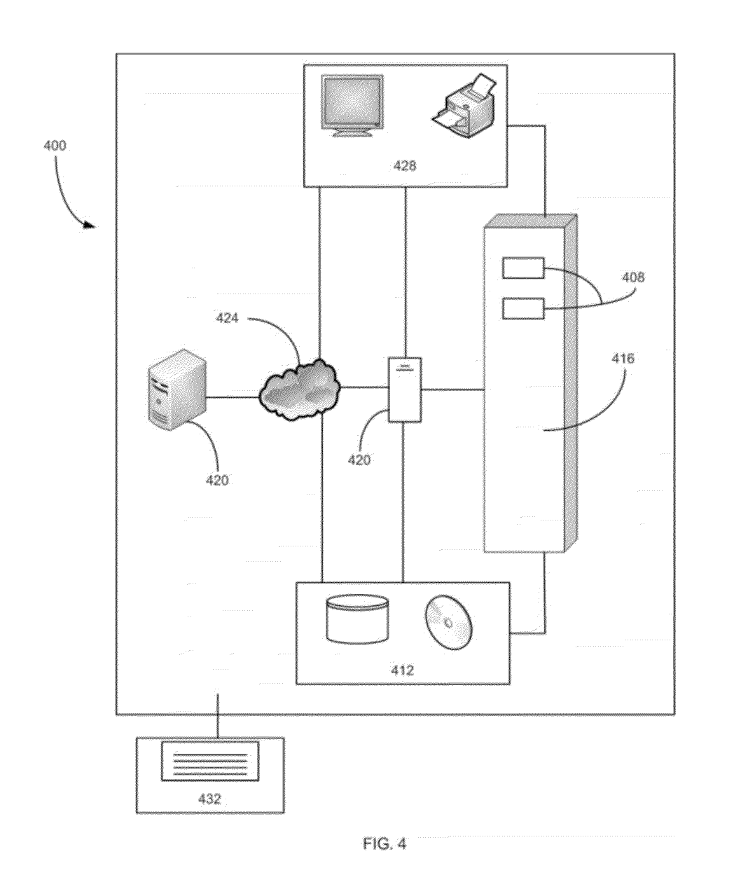

FIG. 4 illustrates an embodiment of an operating environment 400 in which the method of the present disclosure, such as method 100, 200, or 300 can be performed. The operating environment 400 can be implemented in any suitable form, such as a desktop personal computer, a laptop, a workstation, a dedicated hardware component, a handheld device, such as a tablet computer, smartphone, or PDA, or in a distributed computing environment.

The method can be carried out by one or more program modules 408 such as programs, routines, objects, data structures, or objects. The program modules 408 may be stored in any suitable computer readable medium 412, including tangible computer readable media such as magnetic media, such as disk drives (including hard disks or floppy disks), optical media, such as compact disks or digital versatile disks, non-volatile memory, such as ROM or EEPROM, including non volatile memory cards, such as flash drives or secure digital cards, volatile memory, such as RAM, and integrated circuits. The program modules 408 may be stored on the same computer readable medium 412 as data used in the method (such as a library of potential binding partners) or on different media 412.

The method can be executed by, for example, loading computer readable instructions from a computer readable medium 412 into volatile memory 416, such as RAM. In other examples, the instructions are called from nonvolatile memory, such as ROM or EEPROM. The instructions are transmitted to a processor 420. Suitable processors include consumer processors available from Intel Corporation, such as PENTIUM™ processors and the CORE™ series of processors, or Advanced Micro Devices, Inc., as well as processors used in workstations, such as those available from Silicon Graphics, Inc., including XEON™ processors or portable devices, such ARM processors available from ARM Holdings, plc. Although illustrated as a single processor 420, the processor 420 can include multiple components, such as parallel processor arrangements or distributed computing environments. The processor 420 is located proximate the computer readable medium 412, in some examples. In other examples, the processor 420 is located remote from the computer readable medium 412 and information may be transmitted between these computers over a data connection 424, such as a network connection.

Output produced by the processor 420 may be stored in computer readable media 412 and/or displayed on a user interface device 428, such as a monitor, touch screen, or a printer. In some examples, the processor 420 is proximate the user interface device 428. In other examples, the user interface device 428 is located remotely from the processor and is in communication with the processor over a data connection 424, such as a network connection.

A user may interact with the method and operating environment 400 using a suitable user input device 432. Suitable user input devices include, for example, keyboards, pointing devices, such as trackballs, mice, electronic pens/tablets, and joysticks, touch screens, and microphones.

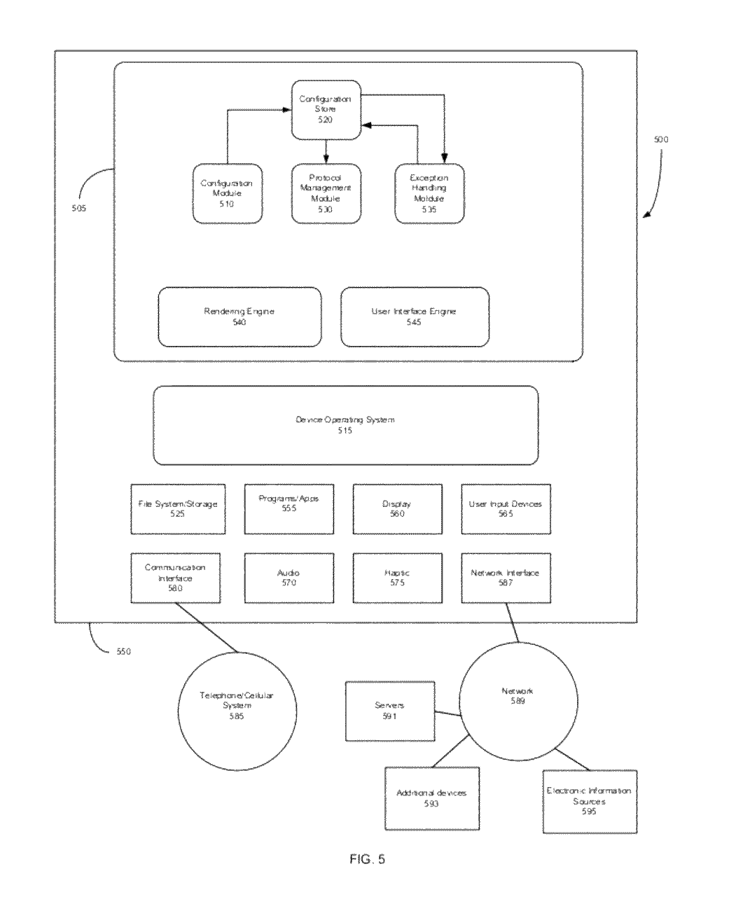

FIG. 5 presents an example software architecture and operating environment, jointly 500, for a limitation protocol tool according to an embodiment of the present disclosure. The software architecture 505 for the limitation protocol tool includes a configuration module 510. In conjunction with a device operating system 515, a user can select limitation protocol parameters using the configuration module 510. Limitation protocol configuration data from the configuration module 510 is stored in the configuration store 520. Actual data may be stored by the operating system 515 on file system/storage 525.

The software architecture 505 includes a protocol management module 530. The protocol management module 530 handles routine operation of the limitation protocol. The protocol management module 530 interfaces with the device operation system 515 and has access to limitation protocol configuration via the configuration store 520/file system/storage 525.

Deviations from routine handling of a limitation protocol, in the embodiment shown in FIG. 5, are processed by an exception handling module 535. Examples of deviations include cheats, lifeline access, notification filters (in some examples), and exceptions filters. The exception handing module 535 is in communication with the device operation system 515 and the configuration store 520/file system/storage 525. As well as reading limitation protocol information from the configuration store 520, the exception handling module 535 can update parameters in the configuration store 520. For instance, lifeline/cheat usage can alter configuration parameters. In a specific example, using a cheat reduces the number of available cheats/increases the cost of available cheats.

The configuration module 510, protocol management module 530, and exception handling module 535 are in communication with a rendering engine 540 and a user interface 545. The rendering engine 540 sends appropriate commands to the device operating system 515 to cause suitable displays/interfaces to be displayed to a user. The user interface engine 545 receives user input commands from the device operating system 515 and forwards them to the configuration module 510, protocol management module 530, or exception handling module 535. User input can include, for example, taps, swipes, pinch/zoom, keyboard input, stylus input, voice commands, button clicks, etc.

The device operation system 515 provides an interface between the software architecture 505 and additional features of a device 550 (such as a PDA, smartphone, tablet, netbook, laptop, desktop computer, etc). In addition to the file system/storage 525, the device operating system 515 can interface with one or more of other programs/apps 555 (which may contain electronic information sources), a display 560, one or more user input devices 565 (touch screen, keyboard, microphone, stylus, buttons, etc.), an audio system 570 (such as speakers/microphones), a haptic feedback system 575 (such as vibration devices). The device 550 further includes a communication interface 580 (for connecting to telephone/cellular systems 585, SMS systems, etc., wifi, Ethernet, 3G/4G data networks etc). The device 550 also includes a network interface 589, which can communicate via suitable protocols (TCP/IP, SSL, etc.) with external servers 591, other electronic devices 593, or other electronic information sources 595. External servers 591/electronic devices 593 may also host electronic information sources.

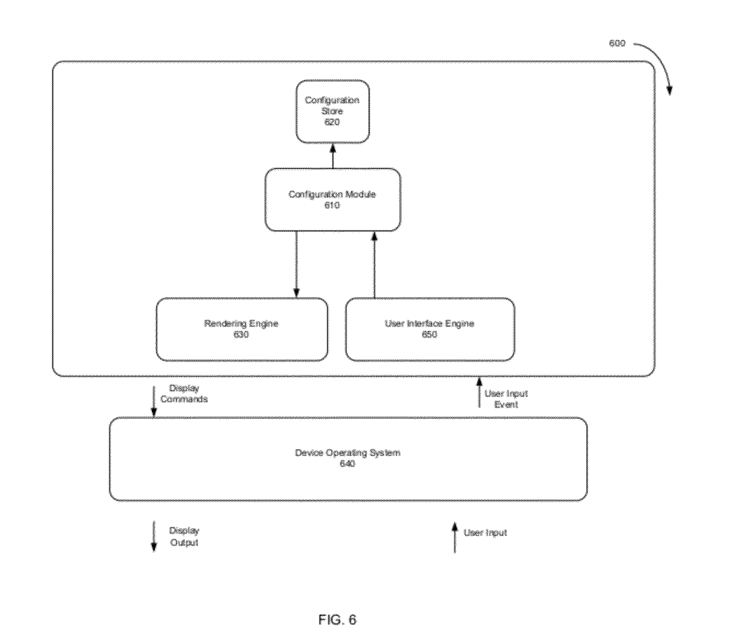

FIG. 6 provides additional detail of a configuration module and its associated operating environment, collectively 600, according to an embodiment of the present disclosure. The configuration module 610 may correspond to the configuration module 510 (FIG. 5). A user interacts with the configuration module 610 to define and/or activate a limitation protocol. Limitation protocol parameters are caused to be stored in the configuration store 620 by the configuration module 610. The configuration module 610 communicates with a rendering engine 630 to provide display commands to a device operating system 640. The device operating system 640 provides display output to a display (not shown).

The device operating system 640 receives user input from a user input device (not shown). The user input events are transmitted by the operating system 640 to a user interface engine 650. The user input engine 650 translates user input for use by the configuration module 610.

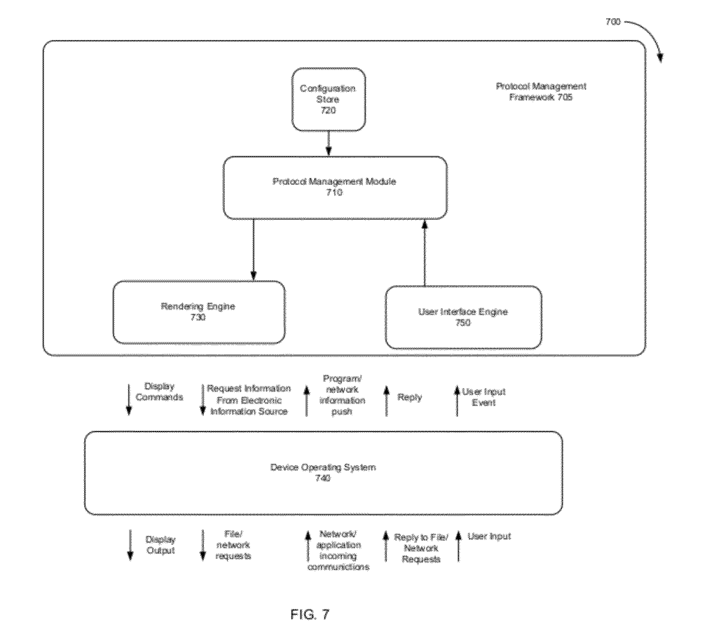

FIG. 7 provides additional detail of a protocol management module and its associated operating environment, collectively 700, according to an embodiment of the present disclosure. The protocol management module 710 may correspond to the protocol management module 530 (FIG. 5). The protocol management module 710 manages routine administration of the limitation protocol. The protocol management module 710 retrieves limitation protocol parameters from the configuration store 720, which may correspond to the configuration store 520 (FIG. 5).

The protocol management module 720 may display user interfaces (such as screens) to a user through a rendering engine 730. The rendering engine 730 provides display commands to a device operating system 740, which then provides display output to a display (not shown).

The protocol management framework 705 also interacts with the device operating system 740 to request information from electronic information sources, in response which the device operation system 740 sends file/network requests. The device operation system 740 also receives network/application incoming communications (such information pushes from information sources), and replies to file/network requests. Corresponding program/network information pushes, and replies are transmitted by the device operation system 740 to the protocol management framework 705.

User input is received by the device operating system 740 and corresponding user input events are transmitted by the device operating system 740 to the user interface engine 750. The user interface engine 750 provides information corresponding to the user input to the protocol management module 710.

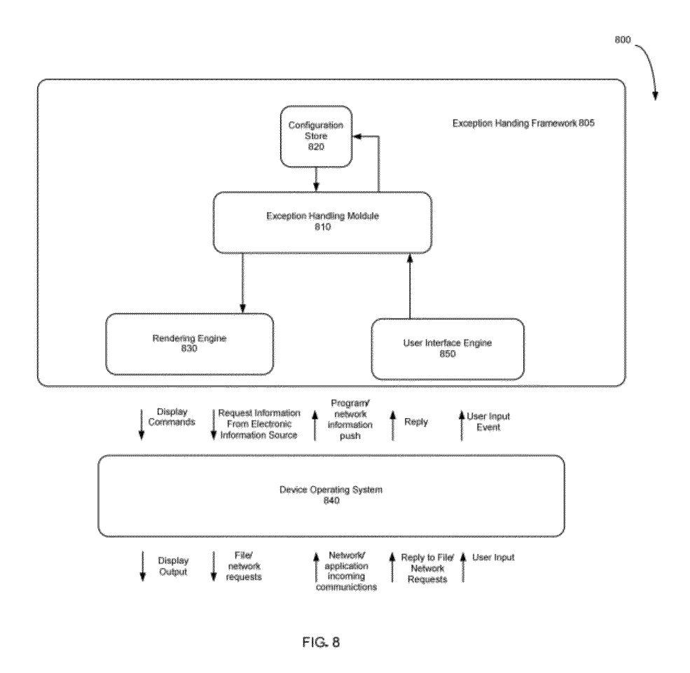

FIG. 8 provides additional detail of an exception handling module and its associated operating environment, collectively 800, according to an embodiment of the present disclosure. The exception handling module 810 may correspond to the exception handling module 535 (FIG. 5). The exception handling module 810 manages exceptions to normal operation of the limitation protocol. For example, the exception handling module 810 may determine whether notification or exception filter criteria have been met and, if so, cause notifications to be generated to a user. The exception handling module 810 also processes requests by the user to create additional access events, such as cheats or lifeline requests.

The exception handling module 810 retrieves limitation protocol parameters from the configuration store 820, which may correspond to the configuration store 520 (FIG. 5).

The exception handling module 810 may display user interfaces (such as screens) to a user through a rendering engine 830. The rendering engine 830 provides display commands to a device operating system 840, which then provides display output to a display (not shown). The display commands may, for example, provide a user access to cheat/lifeline functions or the ability to interact with notification and/or exception filters. In a specific example, the rendering engine notifies a user that notification or exception filter criteria have been met and, at least in some instances, data meeting the filter criteria.

The exception handling framework 805 also interacts with the device operating system 840 to request information from electronic information sources, in response which the device operation system 840 sends file/network requests. The device operation system 840 also receives network/application incoming communications (such information pushes from information sources), and replies to file/network requests. Corresponding program/network information pushes, and replies are transmitted by the device operation system 840 to the exception handling framework 805. Information received by the exception handling module 810 may be processed to determine whether exception/notification criteria have been met.

User input is received by the device operating system 840 and corresponding user input events are transmitted by the device operating system 840 to the user interface engine 850. The user interface engine 850 provides information corresponding to the user input to the exception handling module 810. User input may include, for example, requests to create additional access events (such as cheats or lifelines) or request to access information meeting exception/notification filter criteria.

Although the above description of FIGS. 5-8 describes an example software implementation of the present disclosure, the methods, systems, computer program products, etc. of the present disclosure can have alternate configurations. For example, the software architecture may have more or fewer modules. Functionality may be combined between, for example, the protocol management module 530 and the exception handling module 535. Functionality may also be applied to other or additional modules. For example, notification filters may be handled by the protocol management module 530. Functions of the device operating system 515 or external components may be handled by other hardware/software. In a particular example, some such functions are incorporated into the limitation protocol software architecture 505.

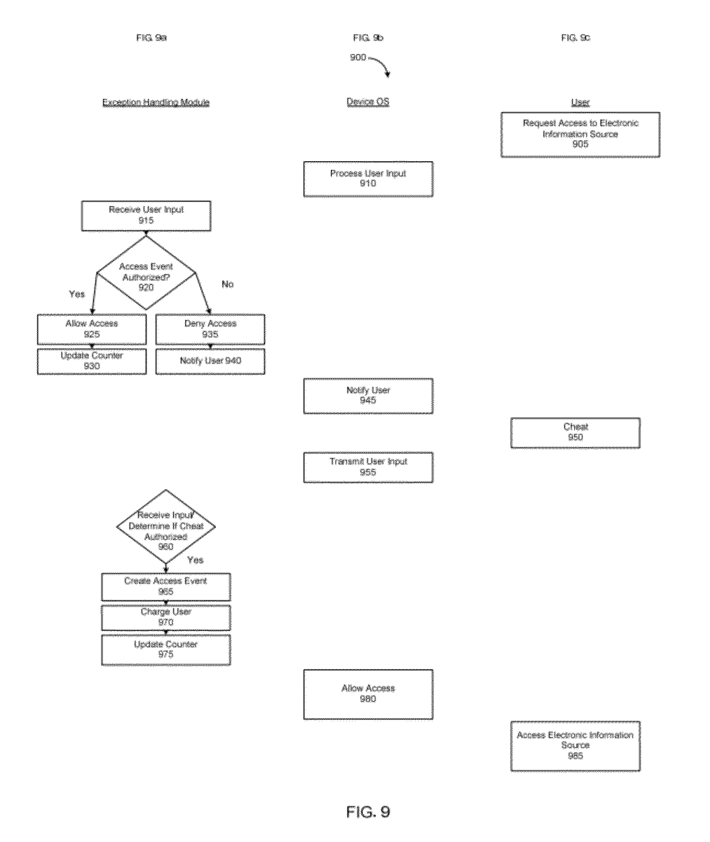

FIGS. 9a-9c illustrate techniques 900 for handling a user request to access an electronic information source and, if an access event is not authorized, for the user to request an additional access event be authorized using a free or pay cheat feature. User actions are shown in FIG. 9c, device operating system actions are shown in FIG. 9b, and software architecture actions, either an exception handling module or a protocol management module, are shown in FIG. 9a. Device operating system actions may be alternatively be included in a software architecture module and software architecture modules may be organized differently than illustrated in FIG. 9.

In step 905 a user requests access to an electronic information source. In step 910, the device operating system receives and processes the user input and forwards the user input to the software architecture, such as the protocol management module. In step 915, the user input is received by the protocol management module. In step 920, the protocol management module determines whether an access event is available. If an access event is available, the user is allowed access to the electronic information source in step 925. In step 930, a counter is updated to indicate the use of an access event, which may, for example, reduce or eliminate the availability of further access events, at least for a time period.

If, in step 920, it is determined that an access event is not authorized, the user is denied access to the electronic information source in step 935. In step 940, the protocol management module generates a request to notify the user that an access event is not available and transmits the request to the device operating system. In step 945, the device operating system receives the notification requests and transmits the request (potentially through an intermediary (not shown)) to the user.

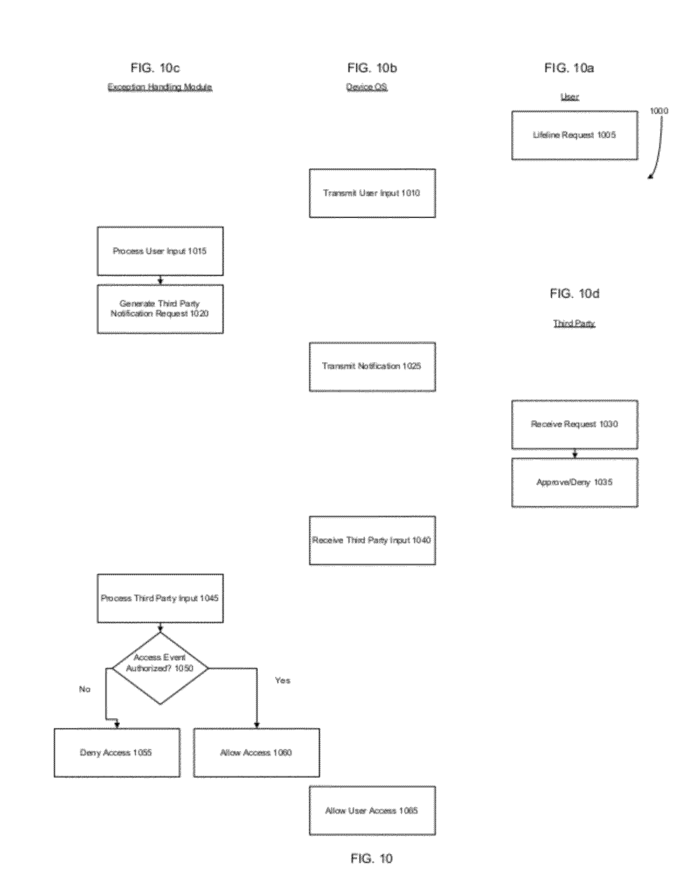

In some cases, the method 900 may end at this point if the user chooses not to take additional action, such as to wait until a regularly scheduled access event becomes available before accessing the electronic information source. In other cases, the user may choose to take action to make an additional access event available. In FIG. 9, the user action is to activate a cheat, which may be a free or pay cheat. In FIG. 10, discussed further below, the user action is to request a lifeline.

In step 950, the user chooses to activate a cheat feature, which command is transmitted to the device operating system. The user input is received by the device operating system and transmitted to the software architecture, such as the exception handling module, in step 955. In step 960, the cheat request is received by the exception handling module. If a cheat is not available, the method ends. If a cheat is available, an additional access event is created by the exception handling module in step 965. If a fee is due for use of the cheat, the user is charged for the cheat in step 970. In step 975, a counter is updated to reflect use of a cheat, such as reducing the number of cheats available or incrementing the fee for using additional cheats. The authorization of an additional access event is received and processed by the device operating system in step 980. In step 985, the user is allowed to access the electronic information source (and, optionally, make changes to the limitation protocol).

FIGS. 10a-10d illustrate techniques 1000 for handling a user request to access an electronic information source and, if an access event is not authorized, for the user to request an additional access event be authorized using a lifeline feature. User actions are shown in FIG. 10c, device operating system actions are shown in FIG. 10b, and software architecture actions, either an exception handling module or a protocol management module, are shown in FIG. 10a. Third party actions are shown in FIG. 10d. Device operating system actions may be alternatively be included in a software architecture module and software architecture modules may be organized differently than illustrated in FIG. 10. In FIG. 10, the techniques assume that steps 905-945 have already occurred. In step 1005 a user makes a lifeline request that is transmitted to the device operating system. Alternatively, the user may directly contact the third party to request an additional access event and means provided for the third party to authorize such access. In yet another alternative embodiment, a third party may authorize an additional access event even without being requested by the user, such as when the third party becomes aware that a communication of particular importance needs to come to attention of the user.

After step 1005, in step 1010, the user input is received by the device operating system and transmitted to the software architecture, such as an exception handling module. The exception handling module process the user lifeline request in step 1015. In step 1020, a third party notification request is generated by the exception handling module and transmitted to the device operating system. The third party notification request is received by the device operating system in step 1025 and transmitted to the third party. The third party receives the notification in step 1030 and approves or denies an additional access event in step 1035.

In step 1040, the third party input is received by the device operating system and transmitted to the exception handling module. The third party input is received and processed by the exception handling module in step 1045. The exception handling module determines whether an additional access event is authorized is step 1050. In step 1055, if an additional access event was not authorized, the user is denied access to the electronic information source and optionally notified (not shown). In step 1060, if an additional access event was authorized, the exception handling module transmits a request to the device operating system to allow access to the electronic information source. The device operating system allows the user access to the electronic information source in step 1065.

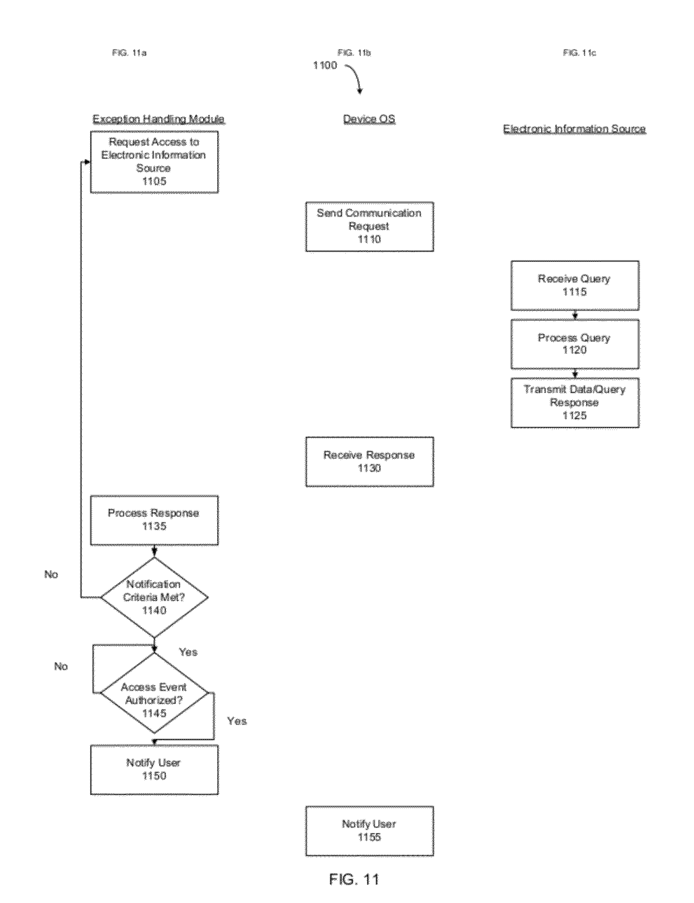

FIGS. 11a-11c illustrate techniques 1100 for handling notification filter criteria. Electronic information source actions are shown in FIG. 11c, device operating system actions are shown in FIG. 10b, and software architecture actions, either an exception handling module or a protocol management module, are shown in FIG. 11a. Device operating system actions may be alternatively be included in a software architecture module and software architecture modules may be organized differently than illustrated in FIG. 11.

In step 1105, the exception handling or protocol management module (referred to throughout the rest of this figure description as the software architecture) sends a request to the device operating system to access (pull information from) an electronic information source. The communication request is received, processed, and an electronic information source query generated and forwarded by the device operating system in step 1110.

The query is received by the electronic information source in step 1115 and processed in step 1120. A response (such as information or information query criteria) is forwarded by the electronic information source to the device operating system in step 1125. The response is received by the device operating system in step 1130 and forwarded to the software architecture.

In step 1135, the software architecture processes the response from the electronic information source. The software architecture determines whether notification filter criteria are met in step 1140. In step 1145, if notification filter criteria are met, the technique determines whether an access event is available, otherwise (if the criteria are not me) the technique ends. If an access event is available, a request to notify the user generated in step 1150 and transmitted to the device operating system. The device operating system receives the request and sends a notification request to the user in step 1155. If an access event was not available in step 1145, the technique waits (repeats step 1145) until an access event is available.

The technique described above with respect to FIG. 11 is generally applicable when information is pulled from an electronic information source. The technique of FIG. 11 can be adapted to information pushes from the electronic information source, with the technique activating at step 1125.

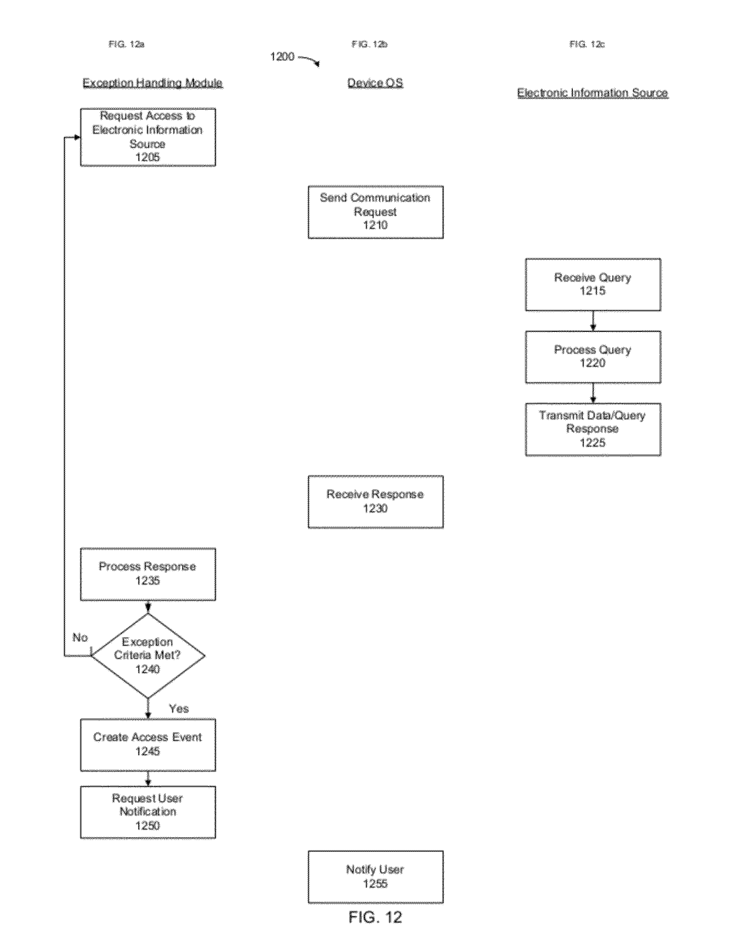

FIGS. 12a-12c illustrate techniques 1200 for handling exception filter criteria. Electronic information source actions are shown in FIG. 12c, device operating system actions are shown in FIG. 12b, and software architecture actions, either an exception handling module or a protocol management module, are shown in FIG. 12a. Device operating system actions may be alternatively be included in a software architecture module and software architecture modules may be organized differently than illustrated in FIG. 12.

In step 1205, the exception handling or protocol management module (referred to throughout the rest of this figure description as the software architecture) sends a request to the device operating system to access (pull information from) an electronic information source. The communication request is received, processed, and an electronic information source query generated and forwarded by the device operating system in step 1210.

The query is received by the electronic information source in step 1215 and processed in step 1220. A response (such as information or information query criteria) is forwarded by the electronic information source to the device operating system in step 1225. The response is received by the device operating system in step 1230 and forwarded to the software architecture.

In step 1235, the software architecture processes the response from the electronic information source. The software architecture determines whether exception filter criteria are met in step 1240. In step 1245, if exception filter criteria are met, the software architecture causes an additional access event to be authorized and a user notification request to be generated and transmitted to the device operating system in step 1250, otherwise the technique ends. In step 1255, the device operating system receives the request to notify a user, notifies the user, and allows access to the electronic information source.

The technique described above with respect to FIG. 12 is generally applicable when information is pulled from an electronic information source. The technique of FIG. 12 can be adapted to information pushes from the electronic information source, with the technique activating at step 1225.

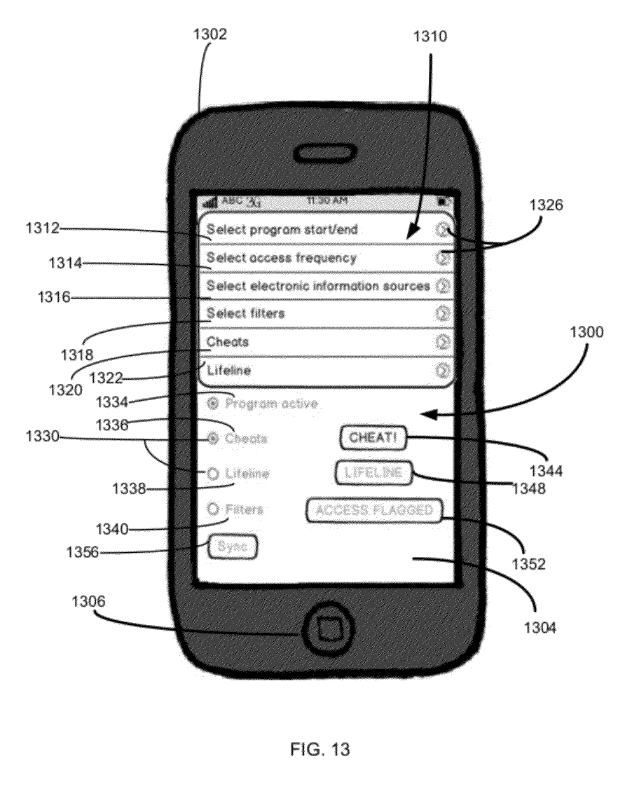

FIGS. 13-19 illustrate sample screens that may be used to carry out the method of the present disclosure, including methods 100-300 (FIGS. 1-3). Although FIGS. 13-19 are shown on a mobile device, the screens could be adapted to other devices, such as laptops, desktops, tablets, etc. FIG. 13 illustrates a home screen 1300. Home screen 1300 is shown implemented on a smartphone or touch screen device 1302 having a screen 1304, such as a touch screen. The device may have other input devices in addition to, or in place of, screen 1304. For example device 1302 includes a button 1306.

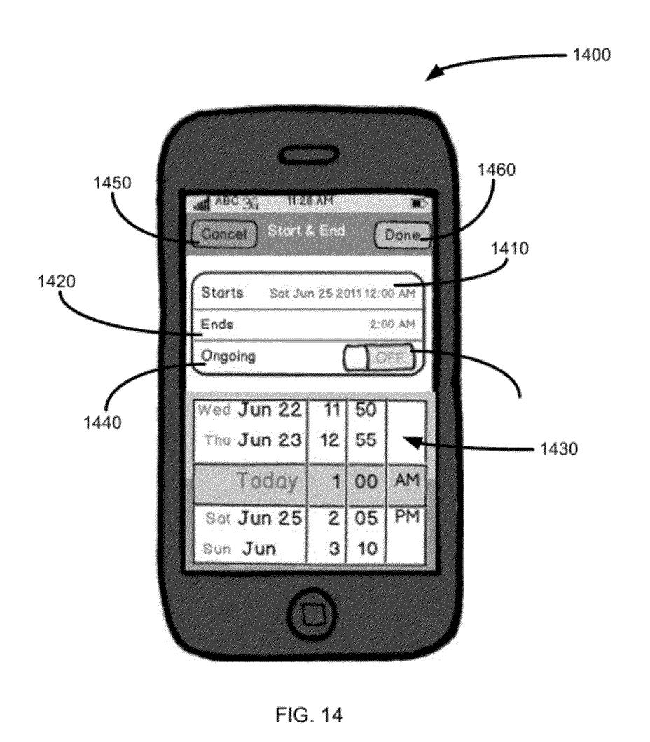

The home screen 1300 includes a menu section 1310 that includes selectable menu items to start/stop a limitation protocol 1312, to select the access frequency/number of access events 1314, to select electronic information sources that will be included in the limitation protocol 1316, to select filters to be applied during the limitation protocol 1318, to determine whether cheats will be active during the limitation protocol and, if so, how they will be configured 1320, and to define whether lifelines will be available and, if so, the identify of the lifelines 1322. When any of the menus 1312-1322 are selected, the user will be presented with another screen to carryout the selected function, as further described with reference to FIGS. 14-19. The menus 1312-1322, in some implementations, are disabled once a limitation protocol has been activated, for the course of the limitation protocol.

The home screen 1300 presents the user with additional items that may be selected, such as using radio buttons 1330. Buttons showing selected items are shown as filled circles. Buttons showing deselected items are shown as open circles. Once a limitation protocol is in effect, the buttons 1330 may be locked out against further changes during the course of the limitation protocol. Locked out items may be indicated in a different manner than active items, such as by showing locked out items in gray text and showing active items in back text. Home screen 1300 illustrates radio buttons 1330 for whether a limitation protocol is active 1334, whether cheats are active 1336, whether lifelines are active 1338, and whether filters are active 1340. Buttons 1334 and 1336 are shown as selected, while buttons 1338 and 1340 are shown as deselected.

Home screen 1300 also may present the user with options to access program features that are available during a limitation protocol. For example, home screen 1300 illustrates icons for accessing the cheat function 1344, accessing lifelines 1348, and accessing information flagged as meeting filter criteria 1352. When the user is given the option to set limitation protocol parameters on another device, such as a personal computer, or through the internet, such as via a website, the user can select an icon 1356 to sync the device 1302 to the other device or website.

FIG. 14 illustrates a sample start/end screen 1400 where a user can set the stop and start dates/times for a limitation protocol. The start/end screen 1400 may be accessed, for example, by selecting field 1312 of FIG. 13. The start/end screen 1400 includes selectable field 1410 for entering a start date and time and a selectable field 1420 for entering a stop date and time. The start 1410 and end 1420 dates may be input, for example, using the time/date wheel 1430. The start/end screen also includes a selectable on/off switch 1440 that may be used to set an ongoing limitation program that starts immediately and has no predefined termination date. The start/end screen 1400 also includes a selectable button 1450 for cancelling out of the screen 1400 and a selectable button 1460 for indicating that the user is done entering dates/and times. Selecting either button 1450 or 1460 will return the user to the home screen 1300 of FIG. 13. The user may be presented with other options in addition to or in place of those shown in FIG. 14. For example, the user might indicate that the program is to start in a specified period of time (e.g., in five minutes, in two hours) and/or run for a specified period of time (e.g., two hours, eight days, three weeks). When the limitation protocol is used to prevent or discourage a driver from accessing an electronic device while driving, the limitation protocol can be set, for example, to start immediately and run for the period of time the driver is expected to be driving. Programs of indeterminate or determinate length may be cancelled, depending on the particular implementation, during an access event, through using a cheat, or by approval of a lifeline or other person with administrator type privileges.

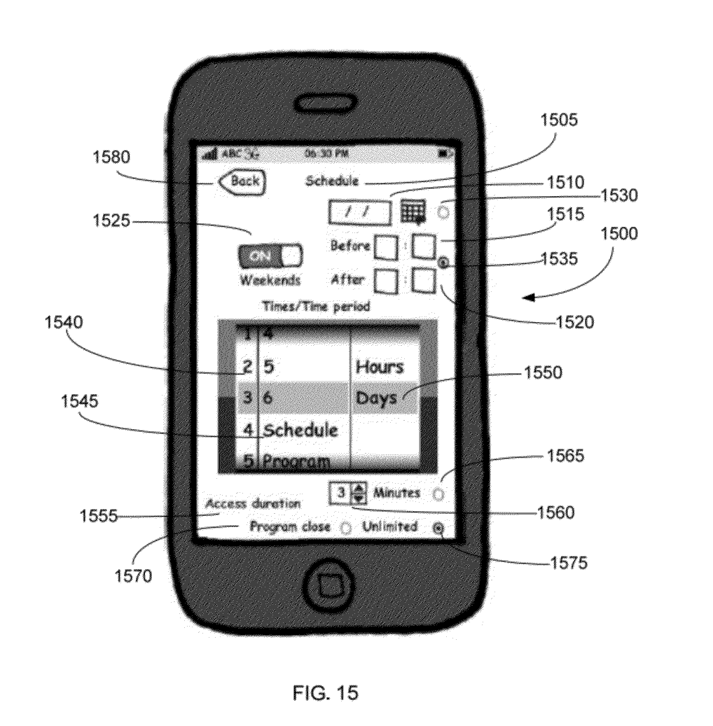

FIG. 15 illustrates a select access frequency screen 1500. Select access frequency screen 1500 may be accessed, for example, by selecting field 1314 of FIG. 13. Screen 1500 includes options 1505 that allow access events to be set according to a particular schedule. A custom schedule may be selecting using calendar icon 1510. In a particular embodiment, calendar icon 1510 is synchronized with a calendar application associated with a device. The calendar application can be used to select particular times and days when one or more access events are allowed. For example, a user may indicate on the calendar that free access to electronic information sources will be permitted during particular days/times, such as during normal business hours. During other times/days, the user may select particular times when access to electronic information sources is restricted according to the limitation protocol. Entry of the desired schedule is, in a particular implementation, analogous to setting appointments in a calendar application.

As an addition or alternative to setting a schedule as described above, by entering appropriate values in before field 1515 and after field 1520, the user may select general hours before and after access to electronic information sources will be freely permitted. The user may choose to restrict weekend access, in addition to, or in place of, the times specified in the fields 1515/1520, using on/off button 1525. A weekend is typically a predefined term. For example, the weekend may defined as between 5 pm Friday and 8 am the following Monday. In some implementations, the user is allowed to alter the definition of a weekend, evening, etc.

The custom schedule option 1510 and before/after option 1515/1520 can be selected using radio buttons 1530 and 1535, respectively. The number of access events in the restricted time periods are selected as further described below.

Wheels 1540, 1545, 1550, allow a user to select the number of access events (wheel 1540) during a given time period (1545, 1550). So, for example, a user may select three access events using wheel 1540. Using wheels 1545 and 1550, the user may indicate that the three access events are to be used every 6 days. The user may also indicate that the number of access events are for a particular portion of the schedule set in field 1505 (the “schedule” option), above, or during the overall duration of the limitation protocol (the “program” option). If neither radio button 1530 nor 1535 is selected, access event frequency will be determined solely by wheels 1540, 1545, 1550. For example, the user may select that one access event is permitted every eight hours.

In field 1555, the user may select the duration of each access event. Using numeric stepper 1560, the user can indicate the number of minutes for the access event. This option can be selected using radio button 1565. The duration of the access event can be specified in other ways, such as when the user closes a program, and can be specified in units other than minutes. Using radio button 1570 the user can specify that the access event will last until the user exits a particular program under control of the limitation protocol. Using radio button 1575, the user can indicate that the access event will last until affirmatively ended by the user.

In some implementations, each program or electronic information source is independently given access events by the limitation protocol. The number of events may be the same or different. Thus, a user could, for example, access email when an access event was authorized, but choose to wait a period of time before accessing text messages. In other examples, all programs/electronic information sources must be accessed at the same time during an access event, including during any time or other termination criteria set for the access event.

Once the access frequency is set, the user may return to the home screen 500 of FIG. 5 using back button 1580.

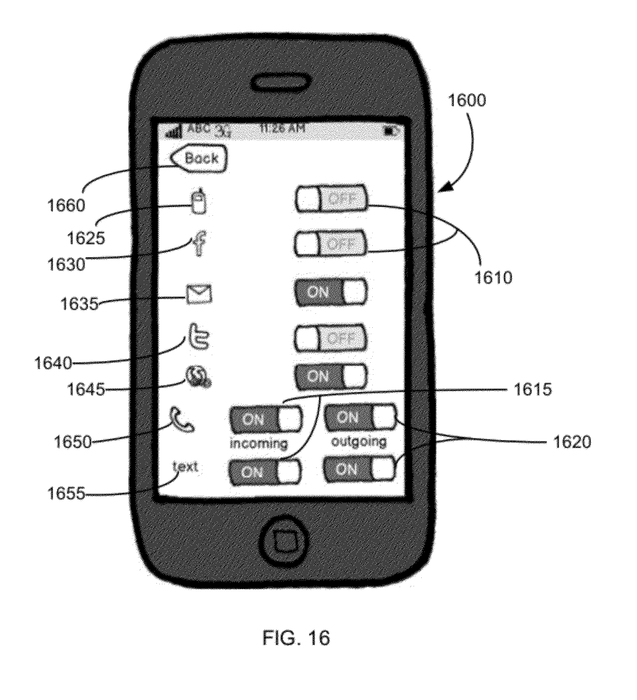

FIG. 16 illustrates an electronic information source selection screen 1600 that can be used to select which electronic information sources will be subject to the limitation protocol. Each electronic information source can be selected as subject or not subject to the limitation protocol using switches 1610. For electronic information sources that include both incoming and outgoing communications/information, incoming 1615 and outgoing 1620 information may be independently controlled using corresponding switches. FIG. 16 illustrates switches for overall device activity (all electronic information sources) 1625, FACEBOOK 1630, email 1635, TWITTER 1640, web access 1645, incoming and outgoing phone calls 1650, and incoming and outgoing text messages 1655. The user may return to the home screen 500 (FIG. 5) using back button 1660.

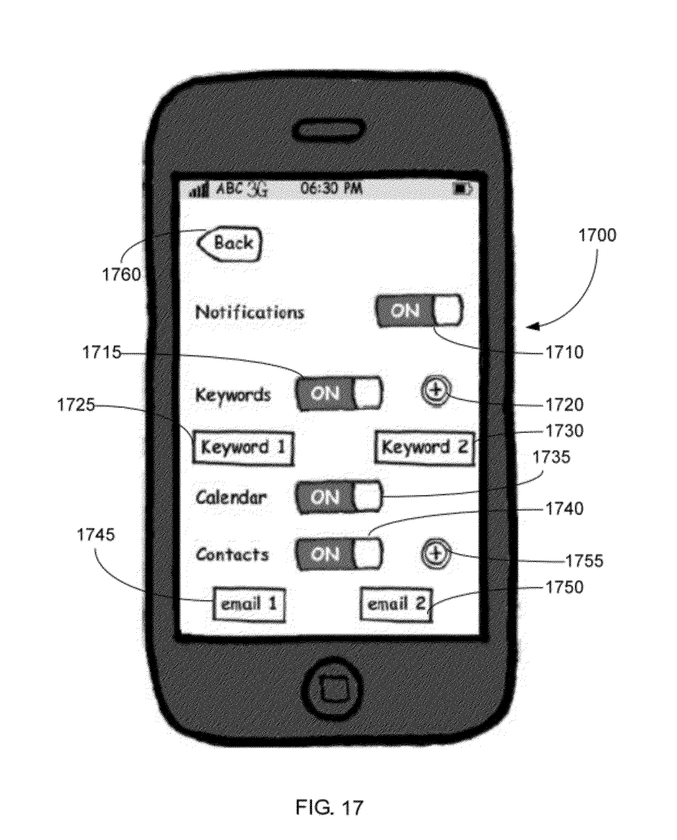

FIG. 17 illustrates a filter selection screen 1700. Filter selection screen 1700 may be accessed, for example, by selecting field 1318 in FIG. 13. The user may select whether notifications are provided when filter criteria are met by appropriate setting of switch 1710. Although not shown, the user may also be provided with options for how notifications are received, such as by audio alert, vibration, calling or texting a preselected phone number, emailing a preset account, and similar options. Although FIG. 17 is described with respect to notification filters, a similar screen could be presented for exception filters, in addition to or in place of the screen 1700 for notification filters. Alternatively, the screen 1700 allows the user to select which filter criteria will be for notification filters and which will be for exception criteria.

The user may select particular keywords as active filter criteria using switch 1715. Plus button 1720 may be used to add additional keywords and phrases, which are then indicated, for example, in fields 1725 and 1730. In some embodiments, filter terms may be set using Boolean operators.

By appropriate selection of switch 1735, the user may choose to sync a calendar to the limitation protocol. For example, communications, such as texts or emails, that are associated with an upcoming calendar item, such as a reminder or meetings, are flagged as meeting filter criteria. Similarly, switch 1740 may be used to select contacts as meeting filter criteria. These criteria may further restricted as to only meet filter criteria when combined with other factors, such as status indicators, for example flags. The user might, for example, specify that only communications having a priority flag, keywords, and/or sent from a particular person will meet the filter criteria.

Selected contacts are indicated in fields 1745, 1750. Although 1745, 1750 are listed as email accounts, other type of contact information may be used as filter criteria. For example, FACEBOOK or TWITTER accounts or phone numbers may be used as contact filter criteria. The user may also specify that all accounts associated with a particular contact are to be used as filter criteria. Additional contacts can be added using plus button 1755. The user can return to the home screen 1300 (FIG. 13) using back button 1760.

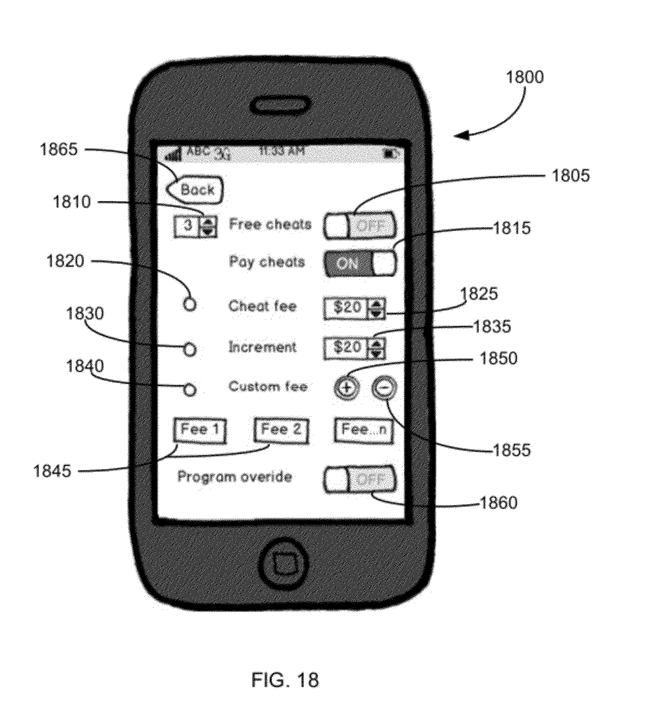

FIG. 18 illustrates a cheat configuration screen 1800 that may be accessed, for example, using button 1320 of FIG. 13. Free cheats may be selected using switch 1805. The user may choose the number of free cheats using numeric stepper 1810.

Pay cheats may be selected by the user by appropriate setting of switch 1815. A set cheat fee can be set using radio button 1820. The amount of the cheat fee can be altered using numeric stepper 1825. In some cases the cheat fees can include default or minimum (or maximum) fees.

By selecting radio button 1830, the user can have the cheat fee increment as cheats are used. The increment amount can be set by the user using numeric stepper 1835. If the user desires more customized fees, those amounts can be set using custom fee button 1840 and fee amounts 1845. Additional fee amounts can be added using button 1850 or removed using button 1855. A maximum number of cheats may be set by the user or by the software or hardware implementing the limitation protocol.

If desired by the user, typically prior to the implementation of the limitation protocol, the user can determine that cheat activation will allow the user to override the entire limitation protocol, such as using button 1860. For example, after activating the cheat, the user may opt to cancel or modify the limitation protocol.

Once the appropriate parameters have been set, the user may return to the home screen 1300 (FIG. 13) using back button 1865.

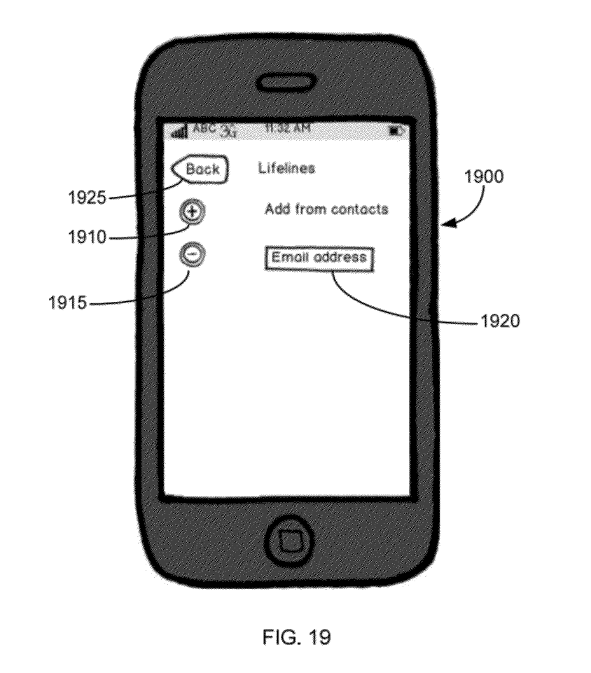

As shown in FIG. 19, the user may select lifelines using screen 1900, such as by selecting button 1322 of home screen 1300 (FIG. 1300). Lifelines are typically added from contacts using button 1910. Contacts can be removed using button 1915. If the lifeline is not in contacts, or contacts use is not desired, contact information for the lifeline, such an email address, can be entered into field 1920. Back button 1925 returns the user to home screen 1300 (FIG. 13).

It is to be understood that the above discussion provides a detailed description of various embodiments. The above descriptions will enable those of ordinary skill in the art to make and use the disclosed embodiments, and to make departures from the particular examples described above to provide embodiments of the methods and apparatuses constructed in accordance with the present disclosure. The embodiments are illustrative, and not intended to limit the scope of the present disclosure. The scope of the present disclosure is rather to be determined by the scope of the claims as issued and equivalents thereto.

I claim:

1. A computer implemented method of limiting access to a program or electronic information source, comprising providing an interface for a user to implement a limitation protocol, the limitation protocol defining a schedule of access events, each access event allowing access to an electronic information source, wherein access to the electronic information source is prohibited unless an access event is available.

2. The method of claim 1, further comprising determining whether a request by the user to access an electronic information source complies with the limitation protocol.

3. The method of claim 2, wherein the user is not allowed to access the electronic information source if the request does not comply with the limitation protocol.

4. The method of claim 1, wherein the limitation protocol has a termination date.

5. The method of claim 4, wherein the interface allows the user to select the termination date.

6. The method of claim 1, wherein the limitation protocol defines a number of allowed access events over a time period.

7. The method of claim 1, wherein the limitation protocol defines a time period between access events.

8. The method of claim 3, further comprising providing the user, via the interface, with the option to create an additional access event if the request does not comply with the limitation protocol.

9. The method of claim 8, further comprising charging the user a fee to create the additional access event.

10. The method of claim 9, wherein the fee is paid to a company providing the interface.

11. The method of claim 9, wherein the fee is defined by the user when the limitation protocol is implemented.

12. The method of claim 1, wherein the interface allows the user to define a notification filter.

13. The method of claim 1, wherein the interface allows the user to define an exception filter.

14. The method of claim 1, wherein the interface allows the user to designate an individual to approve changes to the limitation protocol.

15. The method of claim 1, wherein the interface is implemented on a smart phone.

16. The method of claim 12, further comprising analyzing information from the electronic information source to determine whether it meets the notification filter and, if so and an access event is available, notifying the user of the information.

17. The method of claim 13, further comprising analyzing information from the electronic information source to determine whether it meets the exception filter and, if so, notifying the user of the information.

18. Computer readable medium comprising computer executable instructions for carrying out the method of claim 1.
